(19) United States
(12) Patent Application Publication
(10) Pub. No.: US 2014/0082179 A1
(43) Pub. Date: Mar. 20, 2014

(54) SCARCE RESOURCES MANAGEMENT

(71) Applicant: AVAYA INC., Basking Ridge, NJ (US)

(72) Inventors: Robert C. Steiner, Broomfield, CO (US); Andrew D. Flockhart, Thornton, CO (US); Joylee Kohler, Colorado Springs, CO (US)

(73) Assignee: Avaya Inc., Basking Ridge, NJ (US)

(21) Appl. No.: 13/622,538

(22) Filed: Sep. 19, 2012

(51) Int. Cl. G06F 15/173

(52) U.S. Cl. 709/224

(57) ABSTRACT

A contact center is described along with various methods and mechanisms for administering the same. In general, methods are disclosed that are configured to analyze work assignments to determine one or more scarce resources for further management. By analyzing the attributes, that are common to a number of work assignments made over a period of time, resources possessing those attributes may be classified as scarce. These scarce resources may be managed in accordance with their demand and business rules. To efficiently handle work items associated with valued customers, the scarce resources may be removed from traditional work assignments and held in reserve. The reserved scarce resources may be applied to the valued customers' work items.

### FIELD OF THE DISCLOSURE

The present disclosure is generally directed toward communications and more specifically toward contact centers.

### BACKGROUND

Contact centers can provide numerous services to customers, and have been doing so for years. The idea of a contact center queue is not much different from that of standing in line at a bank and waiting to be helped by the next available teller. However, there can be a lot of frustration if the first, second, or even third teller cannot answer a given question or set of questions. The same frustrations have been known to occur in contact centers. A company can gain customer satisfaction if they are able to answer their customers' questions quickly and accurately.

Contact centers, such as Automatic Call Distribution or ACD systems, are employed by many enterprises to service customer contacts. A typical contact center includes a switch and/or server to receive and route incoming packet-switched and/or circuit-switched contacts and one or more resources, such as human agents and automated resources (e.g., Interactive Voice Response (IVR) units), to service the incoming contacts.

As products and problems become more complex and diverse in nature, a single agent often no longer has all of the skills or expertise to fully service customer contacts. To service customer contacts more effectively, contact centers route contacts to one or more resources with specific skills and attributes. These attributes and/or skills may include but are not limited to proficiency in spoken languages, technical expertise, communication ability (e.g., sign language, TTY, texting, SMS, email, phone, video phone, and the like), preferred work type, and combinations thereof. For example, contact centers that handle computer customer service may have application resources, hardware resources, operating system resources, network resources, etc. While these resources may be well-qualified to answer questions on their particular subject(s), they are often unqualified to answer questions involving subjects outside of their respective skill sets. Still, these resources may be assigned to work items based on at least one attribute, skill, and rule-based match used by a contact center's work assignment mechanism.

It is one goal of a contact center to maintain good customer service when handling contacts, and as such, work items are typically assigned to qualified agents in a timely and efficient manner. Typically, agents may be included in a “work-seeking” group, and as such, can be allocated as required to address various work items. In some cases, however, the suboptimal assignment of one or more work items to resources may go unnoticed by a contact center. As a result, suboptimal assignments may continue and contact center performance as well as long-term customer service may suffer.

### SUMMARY

It is with respect to the above issues and other problems that the embodiments presented herein were contemplated. In general, embodiments of the present disclosure provide methods, devices, and systems that analyze work assignments performed by a contact center, determine scarce resources, and manage those resources based on the scarcity determined. In some embodiments, the scarcity of a resource may be determined by observing work assignments made during a given time period. Additionally or alternatively, the scarcity of a resource may be predetermined based on one or more specific attributes associated with the resource. It is anticipated that the scarcity of a resource may change depending on contact center state and/or work item demand. Examples of attributes that a resource may possess include, without limitation, language ability, fluency for a language, level of understanding for a language, skill (e.g., billing, customer service, troubleshooting, accounts receivable, accounts payable, product knowledge, etc.), skill level (e.g., trainer, trainee, expert, associate, etc.), willingness to participate, attitude rating (e.g., via peer, customer, supervisor, technical, survey, etc.), gender, age, nationality, experience, historical KPIs (e.g., call resolution rate, close rate, conversion rate, etc.), busyness, location, availability, presence information, preferred communication type (e.g., media, medium, real-time, near-real-time, non-real-time, etc.), communication device type, and combinations thereof.

In some embodiments, work assignments may be monitored to determine a scarcity associated with one or more resources. As can be appreciated, the scarcity of a resource may be defined by the number of resources who possess an attribute, or attribute combination, that is in demand at the time the work assignments are being monitored. For instance, each resource in a sub-group of all available resources may possess a specific attribute, or attribute combination, that are considered to be in “high” demand. In other words, the number of work items processed at a contact center requesting handling by a resource having the specific attribute, or attribute combination, may be increasing over time. As the work items are being handled (e.g., being assigned to one or more resources), the number of resources in the sub-group may decrease. Upon reaching a certain threshold, the remaining one or more resources may be classified as scarce. In accordance with embodiments of the present disclosure, the scarce resources may be managed in accordance with predetermined rules. Additionally or alternatively, times of demand may be predicted based on historical data and/or extrapolation of obtained data. In this case, resources may be classified as scarce in anticipation of a predicted demand for an attribute and/or attribute combination. Times of demand may be associated with seasons, times of day/month/year, product launch announcements, recall notifications, earnings and/or other financial reports, publications, contact center state, business rules, and the like.

In one embodiment, a scarcity of a resource may be determined as a limited number of available agents who possess one or more special attributes. Determining the scarcity of a resource may involve reviewing the attributes of a resource and/or evaluating the demand for unique attributes associated with the resource. In some cases, an agent/resource may have unique attributes but very little demand for those unique attributes. For example, an attribute associated with a resource may indicate that the resource speaks fluent Welsh. However, there may be very little, if any, demand for a Welsh speaking resource. Therefore, while the resource may be classified as “rare,” it is not “scarce” for the purposes of this disclosure.

Additionally or alternatively, a value may be associated with the determined scarcity of a resource. For instance, work item allocations to resources may be monitored to measure the level of demand for a resource associated with a scarce attribute, or attribute combination. At first, it may not be apparent to a contact center (or work assignment engine) why one or more resources are allocated work items more often than others, but by monitoring the work assignments over time, a pattern may emerge that can define the value of a resource's scarcity and even isolate the specific attribute, or combination of attributes, that make the resource scarce. In some embodiments, the value (or score) of a resource's scarcity may influence the management of that resource in subsequent work assignments.

It is an aspect of the present disclosure that once a scarce resource is identified, classified, and/or scored as such, the scarce resource may be managed to ensure optimal work assignment matches. Among other things, the scarce resource may be pulled from a “work-seeking” pool to avoid typical and/or general work assignment rules. In the event that a contact center is determined to be in a busy state, the scarce resource may be treated differently from other resources. For example, it is anticipated that a scarcity score may be generated for one or more resources. This score could have one or more ranges that can classify the level of scarcity associated with a resource. In some embodiments, the score may be used to determine whether a resource is considered or even ignored for work assignment. If the score is high, the resource may not be chosen for work assignments by the work assignment engine. Embodiments of the present disclosure anticipate including a scarcity score (for scarce resources and/or non-scarce resources) that ranges from low to medium to high, and may include intermediate levels therebetween.

In some embodiments, a scarce resource may be scheduled according to the scarcity level, or score, associated with the resource. Among other things, the allocation of a scarce resource may be evaluated based on opportunity costs if the resource is allocated to a suboptimal work item. In this instance, the allocation may be affected, altered, inhibited, and/or delayed, based on predictive and/or historical data. The scarce resource may be scheduled to handle specific work items that may demand the attributes associated with the scarce resource and/or be assigned “free” time for working on other work items. In one embodiment, the scarce resource may be associated with an “interruptible” state and corresponding work (e.g., handling emails, training, low-priority work, back-office work, etc.).

In some embodiments, one or more resources may represent an agent, group, queue, site, contact center, and/or combination of work handling entities. For instance, agents, queues, and sites may all be viewed as resources and can be assigned attributes. These attributes may include, but are not limited to, languages spoken, media channels supported, what products or services are supported, and the like. For attributes that are agent specific like occupancy and idle time, for queues and sites the occupancy of the least occupied agent and the idle time of the agent with the longest idle time may be used. In other cases, like handle time, quality scores, or revenue, the average for all agents in the queue or site for the metric may be used. In one embodiment, when the metrics are normalized, agents may be compared to queues and sites to determine scarcity.

It is anticipated that the analysis of work item assignments may be performed automatically via at least one component of a work assignment mechanism of a contact center. This analysis may be performed in real-time, near-real-time, and/or in non-real-time. Additionally or alternatively, the determination and management of scarce resources may be performed automatically via a scarce resource manager. In at least one embodiment, the scarce resource manager may be a part of the work assignment mechanism of a contact center.

In some embodiments, a scarce resource manager may receive at least one of state information, agent selection information, and queue information from one or more contact centers. This resource information may be stored remotely from, or outside of, a work assignment mechanism. Additionally, or alternatively, the information may be stored locally within a memory of a contact center. In one embodiment, the resource information may be stored as data in a table, bitmap, or at least one other database. In some cases, the data may be updated at times to maintain accurate resource information. The update of resource information may be achieved via any one or more of the modes disclosed herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting exemplary pools and bitmaps that are utilized in accordance with embodiments of the present disclosure;

FIG. 3 is a block diagram depicting an emergence of a scarce resource within a resource pool in accordance with embodiments of the present disclosure;

FIG. 4 is a first flow diagram depicting a method of determining and managing scarce resources in accordance with embodiments of the present disclosure;

FIG. 5 is a second flow diagram depicting a method of determining and managing scarce resources in accordance with embodiments of the present disclosure; and

FIG. 6 is a third flow diagram depicting a method of determining and managing scarce resources in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

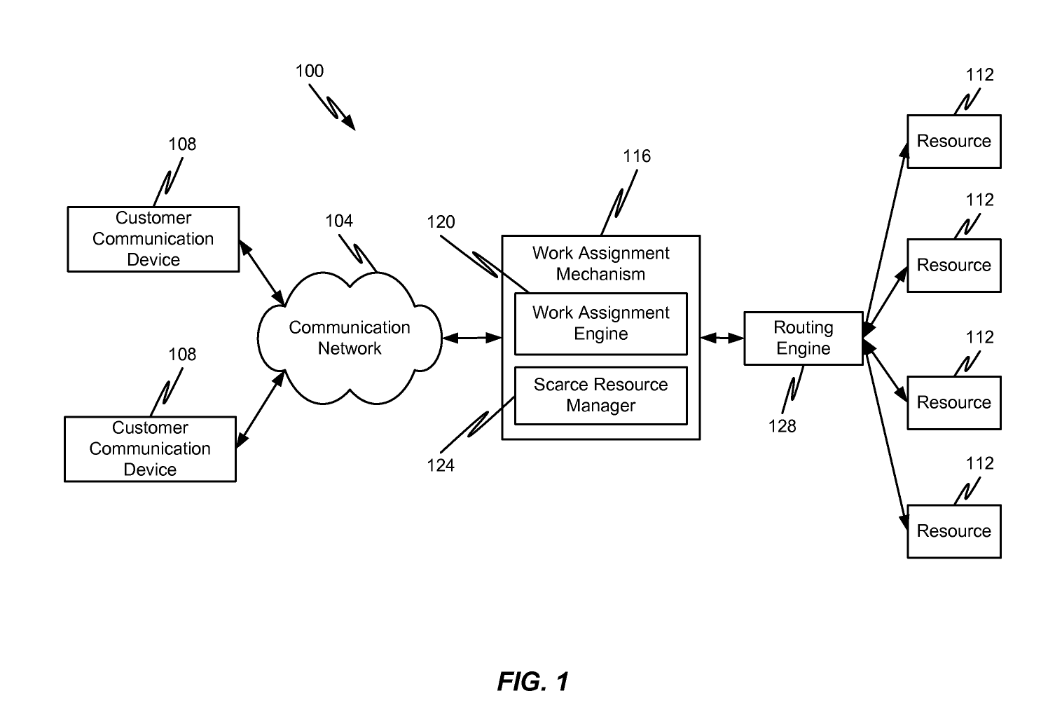

FIG. 1 shows an illustrative embodiment of a communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from the customer communication devices 108.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over Internet Protocol (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively, each of which are hereby incorporated herein by reference in their entirety.

The format of the work item may depend upon the capabilities of the communication device 108 and the format of the communication. In some embodiments, work items are logical representations within a contact center of work to be performed in connection with servicing a communication received at the contact center (and more specifically the work assignment mechanism 116).

Although the routing engine 128 is depicted as being separate from the work assignment mechanism 116, the routing engine 128 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 128.

The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers, and may include contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference.

More specifically, the work assignment engine 120 can determine which of the plurality of processing resources 112 is eligible and/or qualified to receive a work item and further determine which of the plurality of processing resources 112 is best suited to handle the processing needs of the work item. In situations of work item surplus, the work assignment engine 120 can also make the opposite determination (i.e., determine optimal assignment of a work item to a resource). In some embodiments, the work assignment engine 120 is configured to achieve true one-to-one matching.

The work assignment engine 120 may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

In addition to comprising the work assignment engine 120, the work assignment mechanism 116 may also comprise a scarce resource manager 124. As discussed above, the scarce resource manager 124 may be configured as a module that is capable of monitoring and analyzing work assignments in determining the existence of scarce resources. In some embodiments, the scarce resource manager 124 may determine a scarcity score that can be associated with a scarce resource. It is anticipated that the scarce resource manager 124 may be configured to manage scarce resources in affecting work assignments via the work assignment mechanism 116.

Managing scarce resources may involve removing the scarce resources from a work-seeking pool. Additionally or alternatively, each scarce resource may be held in reserve by the scarce resource manager 124 to handle specific work items that meet predetermined criteria. For example, a contact center may be experiencing an increase in contacts that are requesting Spanish-speaking resources. As the Spanish-speaking resources are being assigned to resources, the scarce resource manager 124 may determine that the decrease in resources makes them scarce. In accordance with embodiments of the present disclosure, the scarce resource manager 124 may remove, at least, the Spanish-speaking resources from being assigned via traditional work assignment processes. At some point, the scarce resources may be assigned to work items based on business rules (e.g., if a work item is associated with a contact who is a platinum member, a scarce resource may be assigned to the work item via direction provided by the scarce resource manager 124).

Upon analyzing the work assignments, the scarce resource manager 124 may be configured to determine one or more attributes in demand that make a resource scarce. The scarce resource manager 124 may use the one or more attributes to efficiently identify scarce resources that have, and have not, been assigned to a work item. Identification may include marking each resource as scarce. In some embodiments, this marking may include modifying a bit identifier in a data structure associated with a resource. Once the resources have been identified as scarce, they may be specially managed in work assignments.

It is an aspect of the present disclosure that the scarce resource manager 124 may communicate with the work assignment mechanism 116, its components, and/or other contact center components (e.g., the routing engine 128, resources 112, and the like). Work items may be routed at the direction of the scarce resource manager 124 and/or work assignment engine 120. The routing may include directing the work item to one or more resources. Additionally or alternatively, the routing may include altering the assignment of a work item as directed by the work assignment engine 120. In other words, the scarce resource manager 124 may be incorporated into the work assignment engine 120.

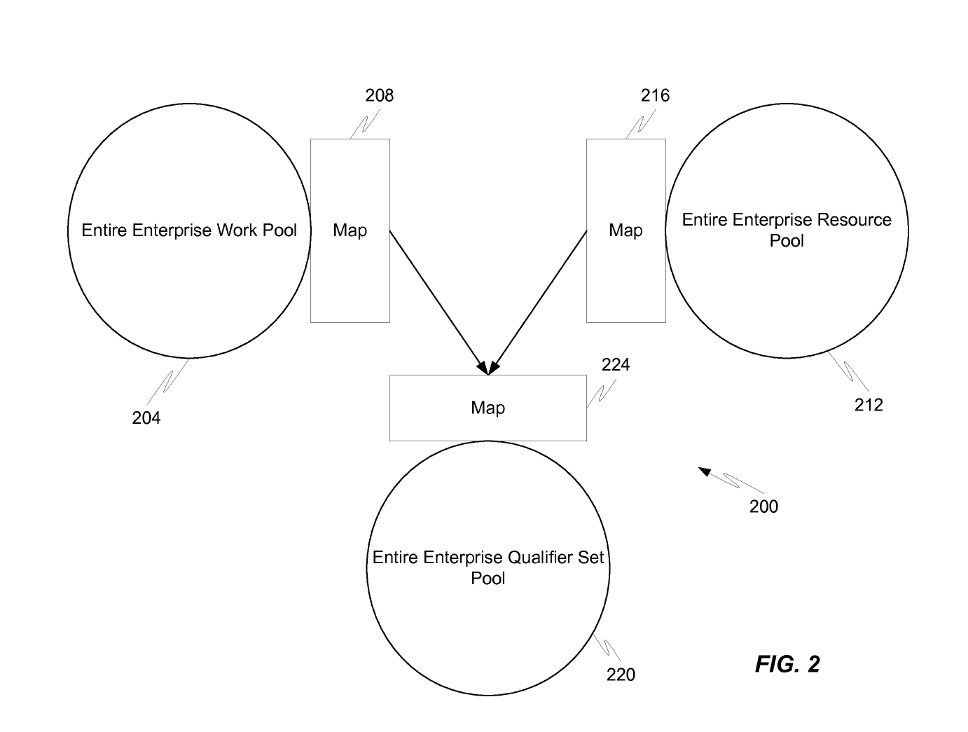

FIG. 2 depicts exemplary data structures 200 which may be incorporated in or used to generate bitmaps/tables used by the work assignment engine 120. The exemplary data structures 200 include one or more pools of related items. In some embodiments, three pools of items are provided, including an enterprise work pool 204, an enterprise resource pool 212, and an enterprise qualifier set pool 220. The pools are generally an unordered collection of like items existing within the contact center. Thus, the enterprise work pool 204 comprises a data entry or data instance for each work item within the contact center.

In some embodiments, the population of the work pool 204 may be limited to work items waiting for service by a resource 112, but such a limitation does not necessarily need to be imposed. Rather, the work pool 204 may contain data instances for all work items in the contact center regardless of whether such work items are currently assigned and being serviced by a resource 112 or not. The differentiation between whether a work item is being serviced (i.e., is assigned to a resource 112) may simply be accounted for by altering a bit value in that work item's data instance. Alteration of such a bit value may result in the work item being disqualified for further assignment to another resource 112 unless and until that particular bit value is changed back to a value representing the fact that the work item is not assigned to a resource 112, thereby making that resource 112 eligible to receive another work item.

Similar to the work pool 204, the resource pool 212 comprises a data entry or data instance for each resource 112 within the contact center. Thus, resources 112 may be accounted for in the resource pool 212 even if the resource 112 is ineligible due to its unavailability because it is assigned to a work item or because a human agent is not logged-in. The ineligibility of a resource 112 may be reflected in one or more bit values.

The qualifier set pool 220 comprises a data entry or data instance for each qualifier set within the contact center. In some embodiments, the qualifier sets within the contact center are determined based upon the attributes or attribute combinations of the work items in the work pool 204. Qualifier sets generally represent a specific combination of attributes for a work item. In particular, qualifier sets can represent the processing criteria for a work item and the specific combination of those criteria. Each qualifier set may have a corresponding qualifier set identified “qualifier set ID” which is used for mapping purposes. As an example, one work item may have attributes of language=French and intent=Service and this combination of attributes may be assigned a qualifier set ID of “12” whereas an attribute combination of language=English and intent=Sales has a qualifier set ID of “13.” The qualifier set IDs and the corresponding attribute combinations for all qualifier sets in the contact center may be stored as data structures or data instances in the qualifier set pool 220.

In some embodiments, one, some, or all of the pools may have a corresponding bitmap. Thus, a contact center may have at any instance of time a work bitmap 208, a resource bitmap 216, and a qualifier set bitmap 224. In particular, these bitmaps may correspond to qualification bitmaps which have one bit for each entry. Thus, each work item in the work pool 204 would have a corresponding bit in the work bitmap 208, each resource 112 in the resource pool 212 would have a corresponding bit in the resource bitmap 216, and each qualifier set in the qualifier set pool 220 may have a corresponding bit in the qualifier set bitmap 224.

In some embodiments, the bitmaps are utilized to speed up complex scans of the pools and help the work assignment engine 120 make an optimal work item/resource assignment decision based on the current state of each pool. Additionally or alternatively, the bitmaps may be utilized by the scarce resource manager 124 in efficiently identifying and managing scarce resources. Accordingly, the values in the bitmaps 208, 216, 224 may be recalculated each time the state of a pool changes (e.g., when a work item surplus is detected, when a resource surplus is detected, and/or when rules for administering the contact center have changed).

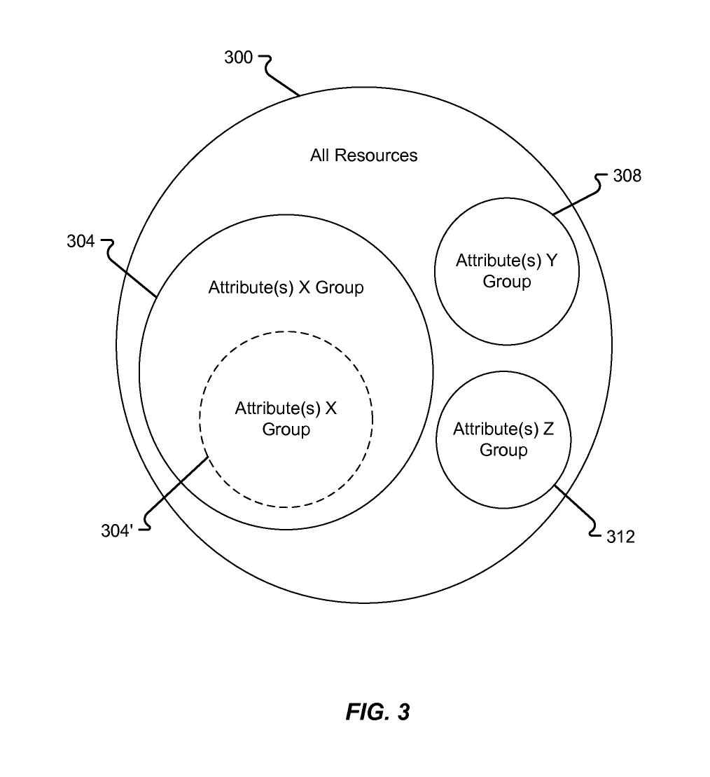

FIG. 3 is a block diagram depicting an emergence of a scarce resource within a resource pool 300. In general, all of the resources 112 (including resources that are available and not available) associated with a contact center and/or enterprise may be considered as members of a general resource pool 300. The members of the general resource pool 300 may be organized into specific groups 304, 308, 312 that can be associated with an attribute, attribute combination, and/or availability. In one embodiment, this organization may be performed via the scarce resource manager 124. In any event, the group may represent one or more attributes that may be associated with select resources 112. For example, the X Group 304 may comprise resources that speak fluent Chinese and are located in China. Alternatively, the X Group 304 may comprise resources that are fluent in a particular language and/or language dialect. The number of the resources 112 available in a given pool may be indicated by the circle size of the groups shown in FIG. 3. For example, a circle that is shown larger than another may comprise more resources. As can be expected a circle depicted smaller than another may comprise less resources.

In one embodiment, the scarce resource manager 124 may observe patterns in work assignments to indicate a particular resource (or attribute/attribute combination) scarcity. Additionally or alternatively, the patterns may predict a future scarcity of one or more resources based on historical data and/or extrapolated data. In any event, these patterns may become evident upon analyzing the allocation of work items to resources 112. For example, and as depicted in FIG. 3, it may be observed that the available resources 112 that share the attribute and/or attribute combination associated with the X Group 304 is decreasing or has decreased. In other words, when it is noticed that X Group 304 has decreased to a reduced size X Group 304′, the scarce resource manager 124 may act to, among other things, identify the available resources 112 in X Group 304′ as scarce. Identifying one or more resources 112 as scarce may involve comparing the number of resources 112 available in a particular group to the demand for the one or more attributes associated with that group.

In another embodiment, scarce resources may be predetermined and/or identified based on historical data and/or business rules. For example, one or more resources 112 may be associated with an attribute or attribute combination in the Y Group 308. The Y Group 308 attribute combination may comprise a technical expertise level and handling efficiency. Based at least partially on historical data, it may be determined that this combination of attributes is always in demand. As such, the resources associated with the Y Group 308 may be identified as scarce.

In accordance with embodiments of the present disclosure, scarce resources may be associated with a score, or level, to indicate a relative scarcity of the resource 112. This scarcity score may be used in determining a management of a resource 112. For instance, scarcity scores may indicate the relative demand for one or more resources 112. When determining work assignments, it may be beneficial to utilize low scarcity resources 112 before high scarcity resources 112. In this case, the highly scarce resources can be reserved for special work assignment as may be directed by business rules.

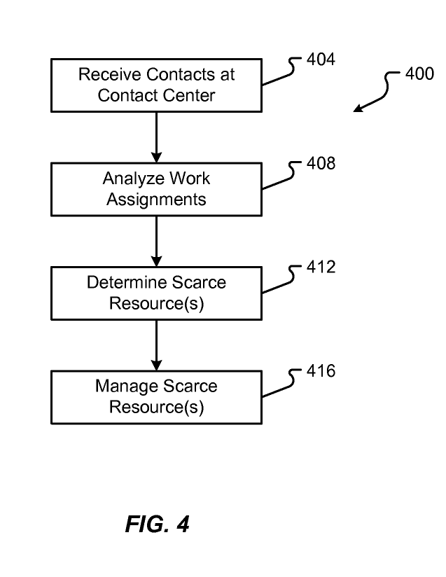

Referring now to FIG. 4, a first flow diagram is provided in accordance with embodiments of the present disclosure depicting a method 400 of determining and managing scarce resources. The method 400 begins at step 404 when contacts are received by the work assignment mechanism 116 of a contact center. Once each work item is created to represent each contact, the work assignment mechanism may proceed by assigning work in accordance with one or more selection mechanisms.

The work assignments may be analyzed to determine one or more of requested attributes, matched resources, work item grade (e.g., customer paid-for quality level), frequency of requests, time of request, contact center state/condition, coincident enterprise events, and patterns of the same (step 408). The analysis may be performed online and/or offline. Additionally or alternatively, the analysis may be performed in real-time, near-real-time, and/or non-real-time. In other words, the real-time analysis may include analyzing work assignments as they are being made by a work assignment engine 116. Real-time analysis may provide efficient ad hoc identification of scarce resources in an operating environment. On the other hand, non-real-time analysis may include analyzing work assignments after they have been made by a work assignment engine 116. Among other things, non-real-time analysis may be used to determine scarce resources that can be identified as such based on historical data.

The method 400 continues by determining scarce resources (step 412). Based at least partially on the analysis performed in step 408, any scarce resources that exist may be determined and even identified. As previously disclosed, scarcity may be defined by demand for an attribute or attribute combination. Scarcity may be assigned based at least partially on the number of resources possessing a specific attribute or attribute combination. In some embodiments, scarcity may be assigned and/or modified by observing a change (e.g., increase or decrease) in the number of resources possessing a specific attribute or attribute combination over time (e.g., as work assignments are being made).

The method 400 continues by managing one or more of the identified scarce resources (step 416). Among other things, the management of the scarce resources may be used to optimize work assignments to valued customers. Additionally or alternatively, the management of scarce resources may involve removing the scarce resources from one or more work-seeking pools of resources. Removing the scarce resources from a work-seeking pool can allow for the reservation and eventual optimized allocation of a work item to a resource. In some cases, this optimization in work assignment may be at least partially based on business rules. One business rule may classify a customer by value (e.g., associate a customer with a paid-for quality of service level such as Platinum, Gold, Silver, and Bronze, where Platinum takes priority over Gold, Gold takes priority over Silver, and so on). While a scarce resource is removed from a work-seeking state, for example, the scarce resource may be assigned alternative forms of work to remain available for scarce resource allocation (e.g., be assigned to, a break, non-real-time work item, training, etc.). In one embodiment, the scarce resource may be assigned break-type work items. Examples of break-type work items are more fully described in U.S. patent application Ser. No. 13/408,793 to Kohler et al., the entire contents of which are hereby incorporated herein by reference. Alternatively or additionally, the scarce resource may be assigned “free time” until the scarce resource is needed or may be assigned a higher allowable agent idle time within the work assignment engine 120. In some cases, the scarce resource may be assigned to an “interruptible” state (e.g., handling emails, training, low-priority work, back-office work, etc.).

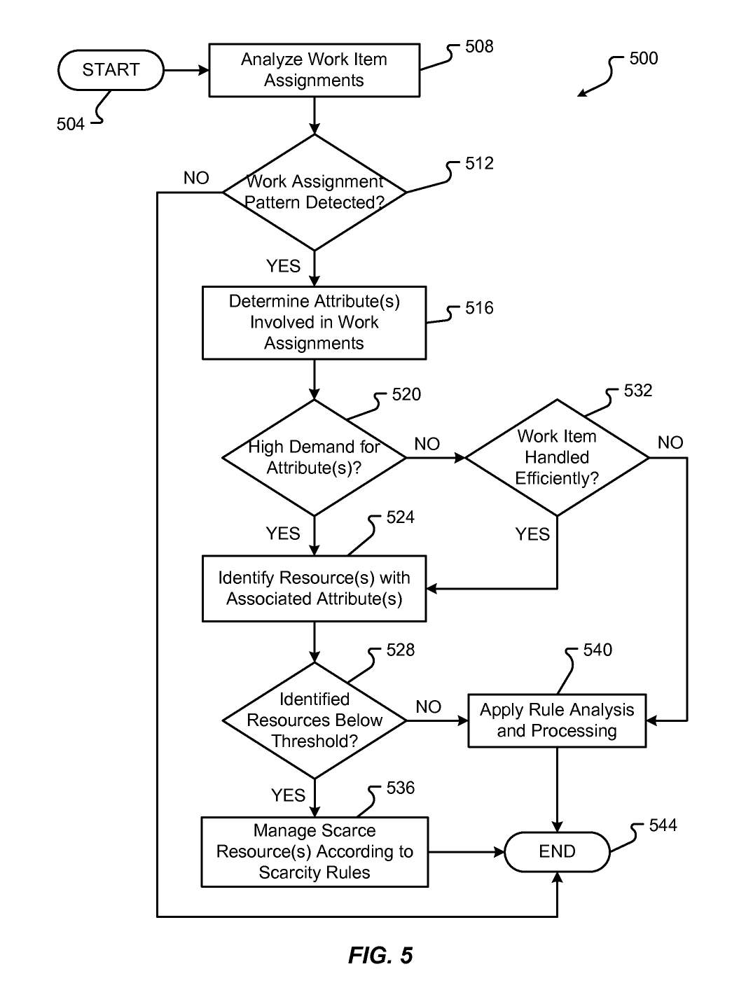

FIG. 5 shows a second flow diagram depicting a method 500 of determining and managing scarce resources in accordance with embodiments of the present disclosure. The method 500 begins at step 504 and proceeds by analyzing work assignments (step 508). As disclosed herein the work assignments that are analyzed may be made at a given contact center, via a work assignment mechanism, a simulator, and/or combinations thereof. The analysis of work assignments may be performed by the scarce resource manager 124. In some embodiments, the analysis may include reviewing each work assignment made for pattern information such as the requested attributes associated with a work item, the attributes associated with any matched resource 112, the number of work items processed, the number of common attribute requests made, the number of resources 112 available, the number of resources 112 assigned, and/or frequency of matches between a given work item and a resource 112.

The method 500 continues by determining whether any work assignment pattern is detected during the analysis step (step 512). In some embodiments, a pattern may be detected if specific instances of pattern information at least partially match with one or more stored pattern condition. For example, a stored pattern condition may correlate the number of incoming work item requests and number of specific available resources 112. In this case, the stored pattern condition may be matched if the number of incoming work item requests is increasing while the number of a specific available resource is decreasing. As can be expected the specific available resource 112 may share one or more common attributes that have been requested in the work assignment.

In the event that a work assignment pattern is detected, the method 500 continues at step 516 by determining the one or more attributes involved in the work assignments performed. In some embodiments, the attributes involved may refer to the attributes requested by the work item and/or the attributes of the resources 112 matched with the requesting work item. It may be determined that one or more attributes are common among a certain number of resources 112 assigned to work items. Although this certain number does not need to be classified as a majority of resources 112, various thresholds may be set to isolate a pattern and/or associate a scarcity score at a later step in the method 500.

Next, the method 500 continues by determining whether there is a high demand for the one or more attributes involved in the work assignments (step 520). The calculation of demand may be based on a number of factors. For instance, demand may be based on a ratio of work item requests and available resources. In some embodiments, the demand may be based on temporal associations with the work item (e.g., the time of the request, the urgency of the request, the frequency between requests, and the like). As disclosed herein, specific thresholds/limits may be preset to determine if one or more attributes are in high demand. For example, 100 work items may be received by a contact center in a 15 minute period where each work item includes a request for attribute “Z.” In the event that only 20 resources possess attribute Z, the pending work items will quickly utilize all available agents at a ratio of 5:1. This ratio, and even any ratio where the number of work items is greater than the number of available resources 112, may cause the method to determine that the attribute is in high demand.

In some embodiments, demand may be based on business rules. For example, a contact center may only experience a few calls from India regarding minor residential power outages. In this example, there may be a number of qualified resources that speak fluent Hindi and are efficient at handling work items. The calls received may be initiated from a number of Platinum-level customers, and as such, there may be a demand for the qualified resources that is based on the business rules regarding customer service quality level.

If there is no high-demand calculated for the attribute or attributes shared by the resources, the method 500 continues by determining whether the work item was handled efficiently by the one or more assigned resource (step 532). As can be appreciated, the efficient handling of work items may be considered as an attribute for the purposes of scarce resource management.

Whether the work item is handled efficiently (e.g., an associated attribute) or if the one or more attributes are in high demand, the method 500 continues by identifying any resources associated with that associated attribute (step 524). Identification may include one or more of finding and marking the resource 112. In finding the resource 112, the scarce resource manager 124 may refer to a bit table containing attribute data of each resource 112. Marking a resource 112 may include altering an entry in the bit table associated with that resource 112. Additionally or alternatively, marking the resource 112 may involve organizing the resource 112 into a group of one or more resources 112. This group may be identified by the one or more attributes that have been determined.

Next, the method 500 continues by determining whether the identified resources 112 are at or below preset scarcity thresholds that may be used to indicate scarcity (step 528). In some cases, a resource 112 may not be scarce until there is a greater demand for the specific resource 112 or a large-scale request for a number of general resources 112. Once the identified resources 112 are determined to be scarce, they may be identified and/or marked as such. In the event that the identified resources are above the scarcity threshold, or if the work item is not handled efficiently (as determined in step 532), the method continues at step 540 by allowing the work assignment mechanism 116 to apply general processing rules in its contact center work assignments.

If, however, it is determined that the identified resources 112 are at or below the scarcity threshold set, the method 500 may continue by managing these resources 112 as scarce in accordance with scarcity rules (step 536). Managing the one or more scarce resources may include removing the resources from a work-seeking pool. For example, a contact center may receive a flood of calls from India regarding massive power outages in the region. Although, the contact center may assign work items to general resources 112 who speak fluent Hindi, the scarce resource manager 124 may determine that the general work-seeking pool of Hindi-speaking resources 112 may include scarce resources. Among other things, these scarce resources may be changed from a work-seeking state to handle work items from India associated with Platinum-level customers. This approach may be beneficial in that the most valuable customers are receiving the best attention. Additionally or alternatively, the scarce resources may be assigned work as directed by the scarce resource manager 124. This assignment of work may replace or supplement the work assignments performed by the work assignment engine 120. After the scarce resources are managed according to scarcity rules, the method 500 may end (step 544).

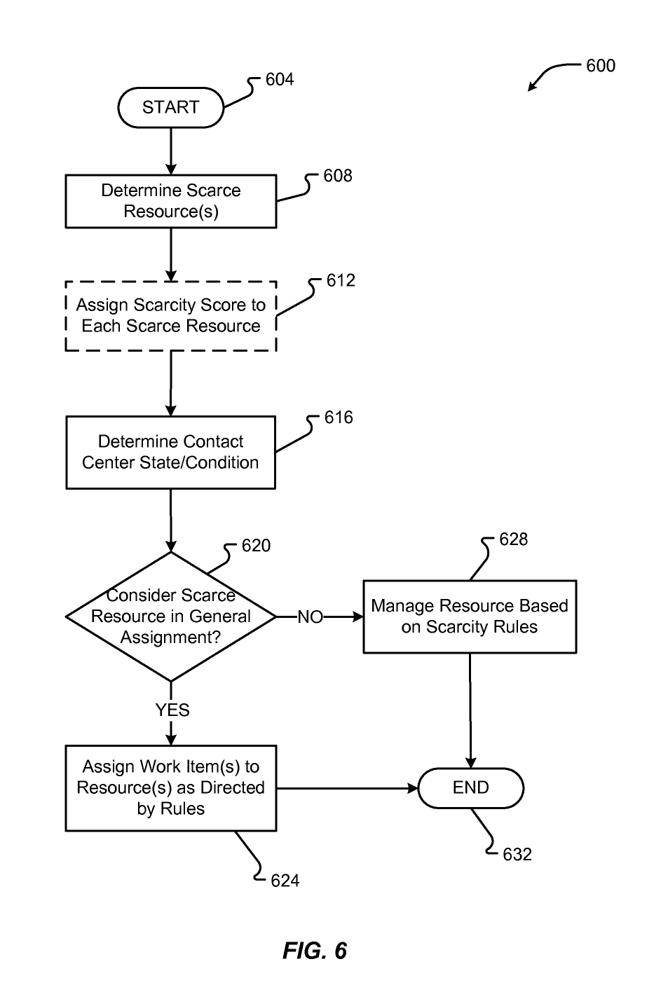

Referring to FIG. 6 a third flow diagram depicting a method 600 of determining and managing scarce resources in accordance with embodiments of the present disclosure. The method 600 begins at step 604 and proceeds by determining any scarce resources in a resource pool (step 608). It is anticipated that the determination of scarce resources in step 608 may be made in any manner disclosed herein. In an optional step, one or more of the scarce resources may be assigned a scarcity score (step 612). The scarcity score may be used to prioritize between multiple scarce resources during the management of the scarce resources. In one embodiment, the scarcity score may be used to rank scarce resources at a contact center and even be used to offer breaks, additional training, and preferred work items to the scarce resources in a ranked manner. As an example, if one scarce resource has a higher scarcity score than another scarce resource, then the scarce resource having the higher scarcity score may be offered a break whereas the other scarce resource may be assigned training that can be easily interrupted, but not as easily as the break can be interrupted.

The method 600 continues by determining a condition, or state, associated with one or more contact center (step 616). For example, in the event of a contact center emergency, the contact center may provide resource 112 information that may be used by the scarce resource manager 124 in determining emergency condition work assignments for scarce resources. In this example, a typical contact center in a state of emergency may assign work items to resources without considering the shortcomings of assigning scarce, and valuable, resources to general work flow. However, in embodiments of the present disclosure, the contact center's scarce resource manager 124 may determine that allocating work items to scarce resources may result in lost opportunities for the scarce resources to handle other, even more important, work items. More important work items may comprise at least one of a paid-for customer service level (e.g., Platinum, Gold, Silver, etc.), a work item associated with urgency (e.g., time dependent work), infrastructure work items (e.g., those work items that relate to contact center function), and the like. Additionally or alternatively, the scarce resource manager 124 may receive updated resource 112 information for the contact center (e.g., that indicates a work-surplus condition). In some cases, the scarce resource manager 124 may deny incoming work assignments to scarce resources. Conversely, at times of low contact center traffic, this condition may cause the scarce resource manager 124 to implement flexibility in work assignments for scarce resources. In one embodiment, the scarce resource manager 124 may remove the scarce resource identifier from one or more resources 112 based on contact center condition, or state. As can be appreciated, the method 600 may be modified in various configurations to suit contact center and/or resource 112 allocation needs. In some cases, a scarce resource may assigned to work to avoid a potential future risk. This predicted future risk may be based on requested queue position and/or allocation of work to the scarce resource. Examples of predicting a future risk state are more fully described in U.S. Pat. No. 8,094,804 to Flockhart et al., the entire contents of which are hereby incorporated herein by reference.

The scarce resource manager 124 may use the contact center state/condition determined in step 616 to determine whether the scarce resource should be considered in general work assignment (step 620). In some cases, the general work assignment may be associated with the typical work assignment selection mechanism used by the work assignment engine 120. In one example, a contact center may be determined to be operating in a state that requires all resources to be assigned to incoming work items. In this case, assigning all of the resources 112 may include overriding any scarce resource management rules. Rules may be predetermined for addressing specific contact center states.

If the scarce resources are considered for general work assignment, the method 600 continues by assigning the work items to the scarce resources as directed by work assignment rules (step 624). In other words, the work items may be routed to the one or more scarce resources based on rules used to assign work to general resources 112. However, if the scarce resources are not considered for general assignment, the method 600 proceeds to step 628 where the scarce resources are managed based at least partially on scarcity rules. The rules may be configured as instructions or data stored in a memory that may be used to allocate the scarce resources based on contact center state and the scarcity associated with those resources. In some embodiments, the scarcity of a particular resource may be based on an assigned scarcity score as described herein. For example, different scarcity scores associated with two scarce resources may cause one resource to be allocated work items, while the other resource may be assigned free time. The scarce resource assigned free time may be “held” in reserve until a valuable work item can be routed to the resource. After the scarce resources have been managed based on scarcity rules (628), or via general work assignment (624), the method 600 ends (step 632).

It should be appreciated that while embodiments of the present disclosure have been described in connection with a queueless contact center architecture, embodiments of the present disclosure are not so limited. In particular, those skilled in the contact center arts will appreciate that some or all of the concepts described herein may be utilized in a queue-based contact center or any other traditional contact center architecture.

Furthermore, in the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

1. A method, comprising:
analyzing, by a scarce resource manager executed by a microprocessor in a server, work assignments made at a contact center, wherein the work assignments include assigning work items to resources;
determining, by the scarce resource manager based on the analysis, a pattern of work assignments, wherein the pattern is at least partially based on attribute data associated with the work assignments;
determining, by the scarce resource manager, a demand for one or more attributes in the attribute data, wherein the demand is based on a ratio of work item requests and available resources at the contact center;
identifying one or more resources that are associated with the one or more attributes as scarce based on the demand determined;
marking, by the scarce resource manager, the one or more scarce resources with a scarcity value, wherein the scarcity value indicates a relative scarcity of the one or more scarce resources, wherein marking includes modifying an identifier in a data structure associated with the one or more scarce resources; and
managing the one or more scarce resources in work assignment allocations based at least partially on the scarcity value of the one or more resources.

2. (canceled)

3. The method of claim 1, wherein managing the one or more scarce resources includes assigning work to the one or more scarce resources having a low scarcity value before work is assigned to the one or more scarce resources having a high scarcity value, wherein the low scarcity value indicates that the one or more scarce resources have fewer of the one or more attributes in demand than the one or more scarce resources having the high scarcity value.

4. The method of claim 3, wherein the one or more scarce resources having the high scarcity value are removed from a work-seeking pool.

5. The method of claim 1, wherein the managing of the one or more scarce resources includes assigning the one or more scarce resources to at least one of a break, and training work item.

6. The method of claim 1, further comprising:
receiving contact center state information, wherein the work assignment allocations are at least partially based on contact center state.

7. The method of claim 1, wherein determining the pattern of work assignments further comprises:
comparing the analyzed work assignments with predetermined pattern conditions.

8. The method of claim 1, wherein the pattern of work assignments is at least partially based on the number of allocated work items made during a given time period.

9. The method of claim 1, wherein determining the demand further comprises:
comparing a number of work item requests that are associated with one or more attributes made with a number of resources available to handle the work item requests.

10. The method of claim 9, wherein the demand is determined to be high when the number of work item requests is greater than the number of available resources.

11. A non-transitory computer readable medium having stored thereon instructions that, when executed by a processor, perform a method comprising:
analyzing work assignments made at a contact center, wherein the work assignments include assigning work items to resources;
determining, based on the analysis, a pattern of work assignments, wherein the pattern is at least partially based on attribute data associated with the work assignments;
determining a demand for one or more attributes in the attribute data, wherein the demand is based on a ratio of work item requests and available resources at the contact center;
identifying one or more resources that are associated with the one or more attributes as scarce based on the demand determined;
marking the one or more scarce resources with a scarcity value, wherein the scarcity value indicates a relative scarcity of the one or more scarce resources, wherein marking includes modifying an identifier in a data structure associated with the one or more scarce resources; and
managing the one or more scarce resources in work assignment allocations based at least partially on the scarcity value of the one or more resources.

12. (canceled)

13. The non-transitory computer readable medium of claim 11, wherein managing the one or more scarce resources includes assigning work to the one or more scarce resources having a low scarcity value before work is assigned to the one or more scarce resources having a high scarcity value, wherein the low scarcity value indicates that the one or more scarce resources have fewer of the one or more attributes in demand than the one or more scarce resources having the high scarcity value.

14. The non-transitory computer readable medium of claim 13, wherein the one or more scarce resources having the high scarcity value are removed from a work-seeking pool.

15. The non-transitory computer readable medium of claim 11, wherein the managing step of the method includes assigning the one or more scarce resources to at least one of a break, and training work item.

16. The non-transitory computer readable medium of claim 11, wherein the method further comprises:
receiving contact center state information, wherein the work assignment allocations are at least partially based on contact center state.

17. The non-transitory computer readable medium of claim 11, wherein the determining the demand step of the method further comprises:
comparing a number of work item requests that are associated with one or more attributes made with a number of resources available to handle the work item requests.

18. The non-transitory computer readable medium of claim 17, wherein the demand is determined to be high when the number of work item requests is greater than the number of resources available to handle the work item requests.

19. A contact center, comprising:
a work assignment mechanism contained in memory and executed by a processor, the work assignment mechanism including:
a work assignment engine configured to compare attributes of work items in a work pool with attributes of resources in a resource pool and match the work items to resources based on the comparison of attributes; and
a scarce resource manager configured to analyze work assignments made at a contact center, wherein the work assignments include assigning work items to resources, determine, based on the analysis, a pattern of work assignments, wherein the pattern is at least partially based on attribute data associated with the work assignments, determine a demand for one or more attributes in the attribute data, wherein the demand is based on a ratio of work item requests and available resources at the contact center, and identify one or more resources that are associated with the one or more attributes as scarce based on the demand determined, mark the one or more scarce resources with a scarcity value, wherein the scarcity value indicates a relative scarcity of the one or more scarce resources, wherein marking includes modifying an identifier in a data structure associated with the one or more scarce resources, and manage the one or more scarce resources in work assignment allocations based at least partially on the scarcity value of the one or more resources.

20. The contact center of claim 19, wherein managing the one or more scarce resources includes assigning work to the one or more scarce resources having a low scarcity value before work is assigned to the one or more scarce resources having a high scarcity value, wherein the low scarcity value indicates that the one or more scarce resources have fewer of the one or more attributes in demand than the one or more scarce resources having the high scarcity value.

21. The method of claim 1, wherein the one or more scarce resources are identified as scarce when the ratio includes more of the work item requests than the available resources at the contact center.

22. The method of claim 1, wherein managing the one or more scarce resources further comprises:
determining an opportunity cost associated with allocating the one or more scarce resources to general work items, wherein a request associated with the general work items excludes the one or more attributes identified as scarce; and
scheduling, in response to determining the opportunity cost, the one or more scarce resources to handle at least one work item requesting the one or more attributes identified as scarce.
